(19) United States
(12) Patent Application Publication
(10) Pub. No.: US 2025/0041712 A1
(43) Pub. Date: Feb. 6, 2025

(54) Handheld Controller with Contact Zone for Constraining Mobile Devices of Differing Sizes

(71) Applicant: Backbone Labs, Inc., Vancouver, WA (US)

(72) Inventors: Maneet Singh Khaira, Vancouver, WA (US); Matty Martin, Vancouver, WA (US); Zachary Scott, Palo Alto, CA (US); Jon Christopher Lake, Sunnyvale, CA (US)

(73) Assignee: Backbone Labs, Inc., Vancouver, WA (US)

(21) Appl. No.: 18/777,919

(22) Filed: Jul. 19, 2024

Related U.S. Application Data
(60) Provisional application No. 63/530,230, filed on Aug. 1, 2023.

(51) Int. Cl. A63F 13/24; A63F 13/235

(52) U.S. Cl. CPC A63F 13/24; A63F 13/235

(57) ABSTRACT

A gaming system having a handheld controller, a bridge, and a contact zone. The bridge connects the first handle and the second handle of the handheld controller. The contact zone is on at least one of the handles and is configured to align and constrain a mobile device in a desired gameplay position that is between the handles. The contact zone has a cross-sectional profile that includes an arcuate section and a chamfered section. The arcuate section has a radius and a center of curvature that is between the first handle and the second handle. The chamfered section has two substantially flat segments meeting at an obtuse angle. At least one of the two substantially flat segments has a length that is not less than one-quarter of the radius of the arcuate section.

### TECHNICAL FIELD

The subject matter is related to an apparatus and methods for positioning a mobile device within a handheld game controller.

### BACKGROUND

The gaming world has recently seen handheld devices entering the market that interface with mobile devices, simulating the traditional console experience while playing on a mobile device. These handheld devices typically consist of two handles—mimicking the grip, button, and joystick configurations of traditional console controllers—and some mode of connecting the handles through a mobile device's primary input port (e.g., lightning, USB-C, etc.). When the device is connected, a user can either run games locally on their mobile device or participate in cloud gaming. In each case, the user can utilize the console-like controller for providing input, as opposed to the phone's own touchscreen or buttons.

A key feature of a mobile game controller is the ability to fit a variety of mobile device models to accommodate more consumers. In addition, mobile devices have a variety of cases, some of which are relatively slim and some of which are relatively thick. Indeed, the mobile device market comprises a wide variety of device models and cases, which possess a wide variety of shapes, sizes, and materials. Some cases provide protection to the mobile device by absorbing shock or protecting the surface of the mobile device from scratches. Other cases may be purely ornamental. Nearly every case, however, alters the size of the mobile device by making it wider, longer, and thicker than it would be without the case. The number of combinations of mobile devices and their cases creates a large number of form factors for the mobile game controller to contain.

Additionally, any tilt or positional misalignment of the mobile device during insertion into a mobile game controller, in addition to being aesthetically undesirable, will cause stress on the connectors between the mobile device and the game controller. It is onerous to require the user to precisely align the mobile device during insertion into the game controller, and such a requirement would reduce user satisfaction with the game controller.

Furthermore, mobile devices are expensive products and any chance of the mobile device inadvertently releasing from the game controller during use or being misaligned with the connector risks damage to the mobile device and can make the game controller feel cheap or flimsy.

Configurations of the disclosed technology address shortcomings in the prior art.

### BRIEF DESCRIPTION OF THE DRAWINGS

FIG. 1 is a perspective view of a handheld game controller, according to an example configuration, illustrating an example mobile device that is secured within the handheld game controller.

FIG. 2 is a perspective view of a handheld game controller, according to another example configuration.

FIG. 3 is a front view of the handheld game controller of FIG. 1.

FIG. 4 is a top view of the handheld game controller of FIG. 1, shown in an example extended position.

FIG. 5 is a top view of the handheld game controller of FIG. 1, shown in an example retracted position.

FIG. 6 is a sectional view as defined in FIG. 5, illustrating a relatively smaller mobile device that is secured within the handheld game controller.

FIG. 7 is a sectional view as defined by viewpoint 6-6 in FIG. 5, illustrating a relatively larger mobile device that is secured within the handheld game controller.

FIG. 8 illustrates several examples of interchangeable, removable adapters, according to example configurations.

FIG. 9 is a perspective view of a handheld game controller, according to an example configuration having removable adapters.

FIG. 10 is a partially exploded view of the game controller of FIG. 9, also showing examples of multiple interchangeable, removable adapters.

FIG. 11 is a front, perspective view of an example adapter.

FIG. 12 is a rear, perspective view of the example adapter of FIG. 11.

FIG. 13 is a portion of a front view of the game controller of FIG. 9, illustrating an example configuration having a mechanical latch coupling the removable adapter to the handle.

FIG. 14 illustrates the mechanical latch of FIG. 13 in an open, or unlatched, condition.

FIG. 15 is a sectional view as defined by the line 15-15 in FIG. 9, illustrating a relatively small mobile device installed into an example of a relatively small adapter of the game controller.

FIG. 16 is a sectional view as defined by the line 15-15 in FIG. 9, illustrating a relatively large mobile device installed into an example of a relatively large adapter of the game controller.

FIG. 17 is a top view of the handheld game controller of FIG. 1, showing example thumb rests.

FIG. 18 is a functional block diagram of a system for implementing the near-field technology, according to an example configuration.

### DETAILED DESCRIPTION

As described herein, aspects are directed to a gaming system that includes a handheld controller with a bridge that connects two handles. A contact zone on at least one of the handles is configured to align and constrain a mobile device in gameplay position. The cross-sectional profile of the contact zone includes different regions, such as an arcuate section and a chamfered section, to accommodate differently sized mobile devices and cases. In configurations, the contact zone is part of a removable adapter that can be interchanged with another removable adapter for a customized fit. Configurations also include an overhang that, in addition to visually and mechanically guiding the user when inserting the mobile device, allows the game controller to accommodate a mobile device whose upper surface is above the upper surface of the game controller's handle. Consequently, configurations of the disclosed technology provide a secure, self-aligning fit across a wide variety of mobile devices and mobile-device cases within a defined size and shape envelope. In addition, configurations allow for customizable user experiences through near-field technologies. Other features are presented, as well.

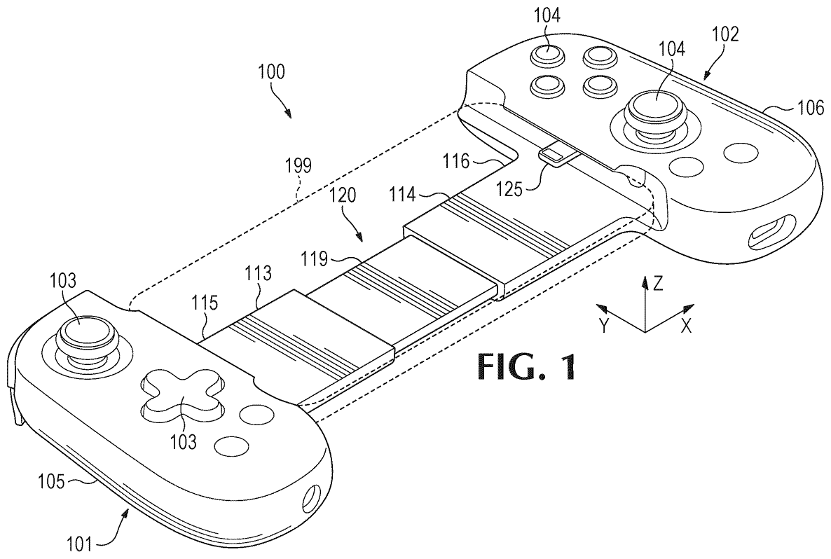

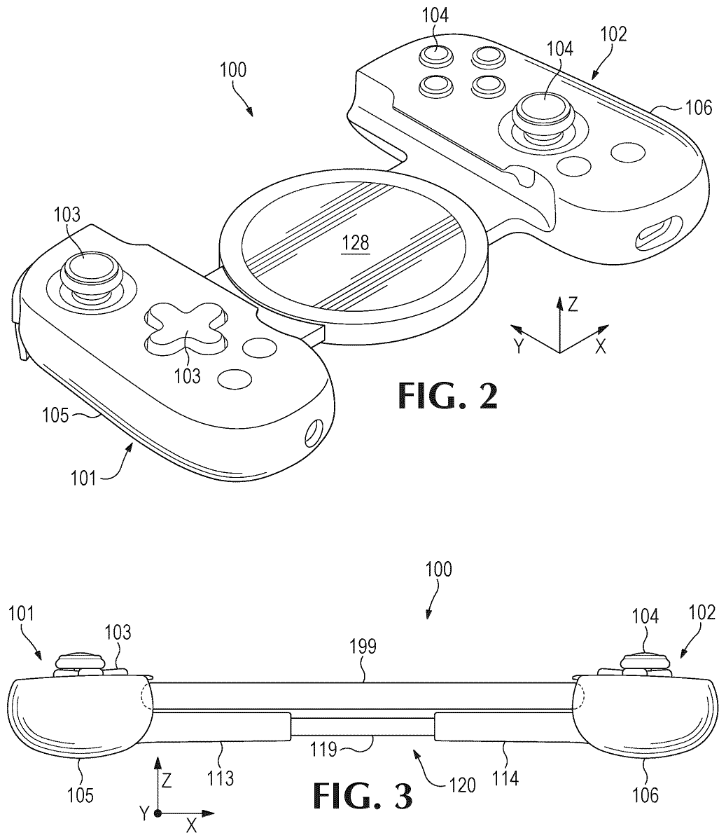

FIG. 1 is a perspective view showing portions of a handheld game controller, according to an example configuration. FIG. 2 is a perspective view showing portions of a handheld game controller, according to another example configuration having a magnetic connector 128. The magnetic connector 128 may be as described in Publication No. US 2022/0331688, which is incorporated here by this reference. While FIGS. 3-5 show the example configuration of FIG. 1, the concepts described for FIGS. 3-5 also apply to the example configuration of FIG. 2.

As illustrated in FIGS. 1 and 2, a game controller 100 may include a first handle 101, a second handle 102, and a bridge 119. Each of the first handle 101 and the second handle 102 is configured to contact and support a mobile device 199, though not all contemplated embodiments will include the second handle 102. An exemplary mobile device 199 is shown in broken lines to illustrate how the game controller 100 may contact and support a mobile device 199 in some embodiments. The mobile device 199 may be, as examples, a smartphone or a tablet computer.

As illustrated in FIGS. 1 and 2, the first handle 101 includes a guide portion 113 and a main body portion 105. The guide portion 113 extends from the main body portion 105 and along a first end 115 of the span 120 of the bridge 119. The guide portion 113 of the first handle 101 is configured to align the bridge 119 with the main body portion 105 of the first handle 101.

As illustrated, the first handle 101 includes a user-accessible, first hardware interface 103 on the main body portion 105 of the first handle 101. The first hardware interface 103 could be a button, an analog stick, a touchscreen, a touchpad, a knob, a slider, a switch, a wheel, a dial, a directional pad, or another such feature configured to accept touch inputs from a user's finger or a stylus. As shown in FIGS. 1 and 2, the first hardware interface 103 may include multiple such hardware interfaces.

Likewise, the second handle 102 includes a guide portion 114 and a main body portion 106. The guide portion 114 extends from the main body portion 106 and along a second end 116 of the span 120 of the bridge 119. The guide portion 114 of the second handle 102 is configured to align the bridge 119 with the main body portion 106 of the second handle 102.

As illustrated, the second handle 102 further includes a user-accessible, second hardware interface 104 on the main body portion 106 of the second handle 102. As above for the first hardware interface 103 of the first handle 101, the second hardware interface 104 could be a button, an analog stick, a touchscreen, a touchpad, a knob, a slider, a switch, a wheel, a dial, a directional pad, or another such feature configured to accept touch inputs from a user's finger or a stylus. The second hardware interface 104 may include multiple such hardware interfaces, as illustrated in FIGS. 1 and 2.

One or both of the first handle 101 and the second handle 102 may include a connector 125 for physical and electrical connection to the mobile device 199. The connector 125 may be, for example, a USB-C connector.

It is noted that most of the drawings include indications showing the directions of mutually orthogonal x-, y-, and z-axes. These are used to orient the reader and to assist with the descriptions of the illustrated configurations. Accordingly, the bridge 119 lies in the x-y plane as illustrated, and the intended gameplay position of the mobile device 199 is substantially parallel to the x-y plane of the bridge 119, such as is illustrated in FIGS. 1 and 3-5. As used in this context, “substantially parallel” (e.g. to the x-y plane) means largely or essentially equidistant (e.g. from the x-y plane) at all points, without requiring perfect parallelism.

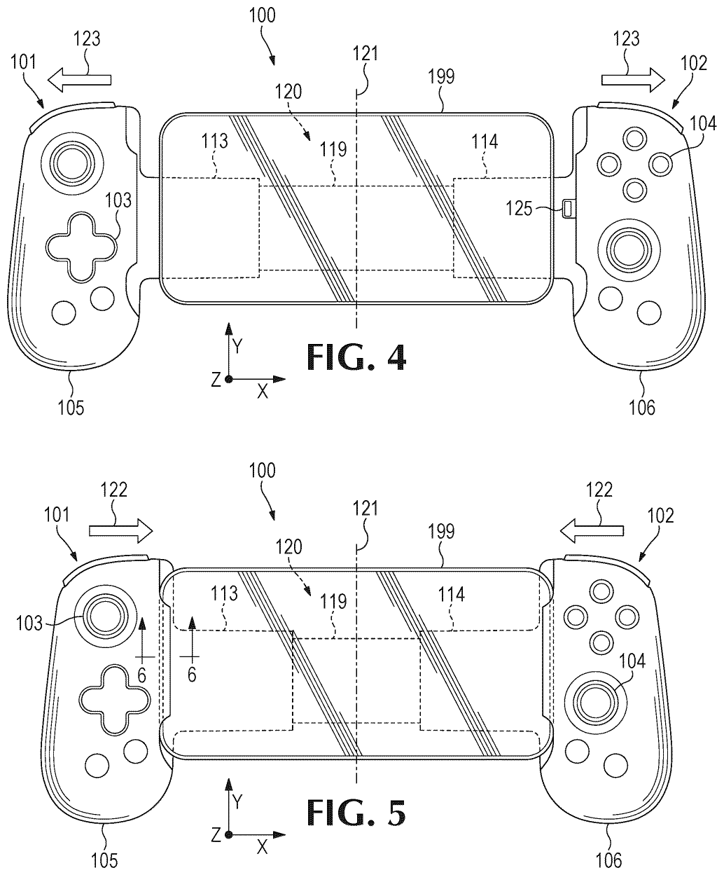

FIG. 3 is a front view of the handheld game controller of FIG. 1. FIG. 4 is a top view of the handheld game controller of FIG. 1, shown in an example extended position. And FIG. 5 is a top view of the handheld game controller of FIG. 1, shown in an example retracted position. FIGS. 3-5 illustrate an example of how a mobile device 199 may be installed into the game controller 100. As illustrated in FIG. 4, the mobile device 199 may be placed over the bridge 119, between the first handle 101 and the second handle 102 of the game controller 100. The connector 125 of the game controller 100 may be joined with a corresponding connector on the mobile device 199. FIG. 4 shows an example of an extended configuration of the game controller 100, where the handles are extended away from each other a sufficient distance to allow the mobile device 199 to be inserted. In FIG. 5, the mobile device 199 is secured between the first handle 101 and the second handle 102 of the game controller 100. FIGS. 3 and 5 illustrate an example of a retracted configuration of the game controller 100, where the handles are retracted toward each other such that the mobile device 199 contacts the contact zone 107 (explained below). The extended configuration and the retracted configuration of the game controller 100 are described in more detail below.

Hence, as illustrated the bridge 119 is in sliding engagement with the first handle 101. In the illustrated configuration, the bridge 119 is not telescoping, meaning that segments of the bridge 119 do not slide within another segment of the bridge 119 to allow for lengthening or shortening of the bridge 119. The bridge 119 has a span 120 extending away from the main body portion 105 of the first handle 101, and the span 120 has a transverse midline 121.

The bridge 119 and the first handle 101 are configured to allow the main body portion 105 of the first handle 101 to translate in a retraction direction 122 toward the midline 121 of the bridge 119 and into a retracted configuration, an example of which is illustrated in FIGS. 3 and 5. The bridge 119 and the first handle 101 are configured to allow the main body portion 105 of the first handle 101 to also translate in an extension direction 123 away from the midline 121 of the bridge 119 into an extended configuration, an example of which is illustrated in FIG. 4.

As used in this disclosure, the transverse midline 121 of the bridge 119 is a reference datum used to define the extension direction 123 and the retraction direction 122. That is, the retraction direction 122 is toward the transverse midline 121, while the retraction direction 122 is away from the transverse midline 121. Accordingly, the transverse midline 121 of the bridge 119 may or may not coincide with a physical structure on the game controller 100.

Likewise, the bridge 119, as illustrated, is in sliding engagement with the second handle 102, and the span 120 of the bridge 119 extends away from the main body portion 106 of the second handle 102. The bridge 119 and the second handle 102 are configured to allow the main body portion 106 of the second handle 102 to translate in the retraction direction 122 toward the midline 121 of the bridge 119 and into the retracted configuration. The bridge 119 and the second handle 102 are configured to allow the main body portion 106 of the second handle 102 to also translate in the extension direction 123 away from the midline 121 of the bridge 119 into the extended configuration.

In configurations, the bridge 119 is configured such that the first handle 101 and the second handle 102 are equidistant from the midline 121 of the bridge 119 in the retracted configuration and in the extended configuration. In configurations, the bridge 119 is configured such that the first handle 101 and the second handle 102 are equidistant from the midline 121 of the bridge 119 when the first handle 101 and the second handle 102 are translating from the retracted configuration to the extended configuration. In configurations, the bridge 119 is configured such that the first handle 101 and the second handle 102 are equidistant from the midline 121 of the bridge 119 when the first handle 101 and the second handle 102 are translating from the extended configuration to the retracted configuration.

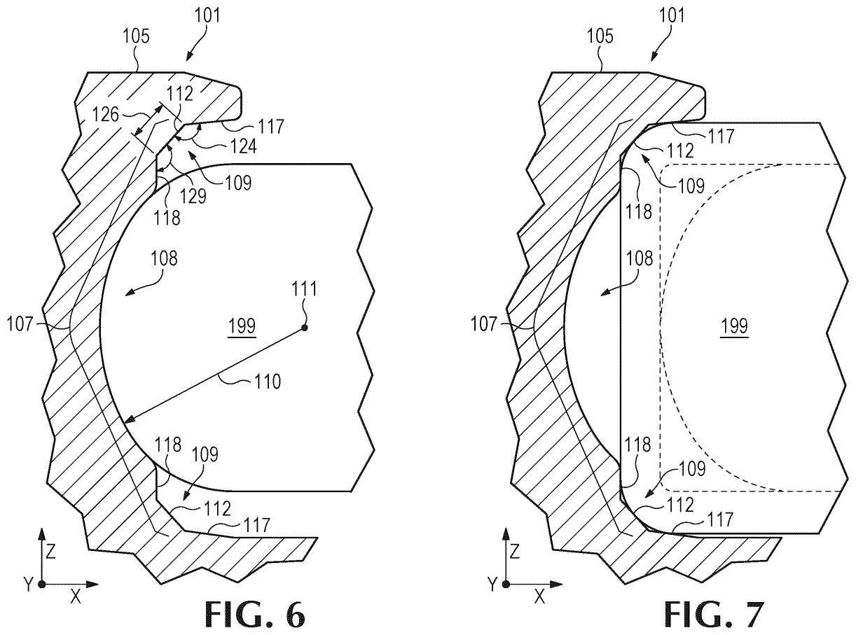

FIG. 6 is a sectional view as defined in FIG. 5, which illustrates a relatively thinner mobile device that is secured within the handheld game controller. FIG. 7 is a sectional view as defined by viewpoint 6-6 in FIG. 5, which illustrates a relatively thicker mobile device that is secured within the handheld game controller. A mobile device may be relatively thicker, as examples, when the mobile device itself has a greater thickness in the z-direction or if the mobile device is within a separate mobile-device case. By way of example only, a relatively thinner mobile device (whether with or without a case) may have a thickness in the z-direction of about 3/16-inch to about 5/16-inch, while a relatively thicker mobile device (whether with or without a case) may have a thickness in the z-direction greater than that. Although the sectional view defined in FIG. 5 is for the first handle 101, the contact zone 107 could also or instead be on the second handle 102.

As shown in FIGS. 6 and 7, one or both of the first handle 101 and the second handle 102 includes a contact zone 107. The contact zone 107 is configured to align and constrain the mobile device 199 into the desired gameplay position, particularly when the game controller 100 is in the retracted configuration. As noted above, the intended gameplay position of the mobile device 199 is substantially parallel to the x-y plane of the bridge 119, with the mobile device 199 being between the first handle and the second handle.

FIGS. 6 and 7 show the cross-sectional profile of an example contact zone 107. As indicated in the drawings, the cross-sectional profile is in the x-z plane, which is perpendicular to the x-y plane. As illustrated, the cross-sectional profile of the contact zone 107 includes an arcuate section 108 and a chamfered section 109. The arcuate section 108 has a radius 110. The center of curvature 111 of the arcuate section 108 is between the first handle 101 and the second handle 102. As illustrated, the chamfered section 109 includes two substantially flat segments 112, 117 meeting at an obtuse angle 124. As used in this context, an “obtuse angle” is an angle that is greater than 90° and less than 180° Preferably, the obtuse angle 124 is between about 1100 and about 170°. More preferably, the obtuse angle is between about 125° and about 155°. Even more preferably, the obtuse angle is between 130° and 140°. As used in this context, “substantially flat” means largely or essentially flat, without requiring perfect flatness. At least one of the two substantially flat segments 112, 117 has a length 126 that is not less than one-quarter of the radius 110 of the arcuate section 108. In configurations, the two substantially flat segments 112, 117 meet at a sharp vertex, and in other configurations the two substantially flat segments 112, 117 meet at a rounded corner.

In configurations, such as illustrated in FIGS. 6 and 7, the chamfered section 109 further comprises a third substantially flat segment 118 that meets the substantially flat segment 112 at an obtuse angle 129. The obtuse angle 129 has the same range of measurements as described above for the obtuse angle 124. In configurations, the two substantially flat segments 112, 118 meet at a sharp vertex, and in other configurations the two substantially flat segments 112, 118 meet at a rounded corner. It is noted that either one of the segment designated 117 or the segment designated 118 in FIGS. 6 and 7 could be the “third” substantially flat segment 112.

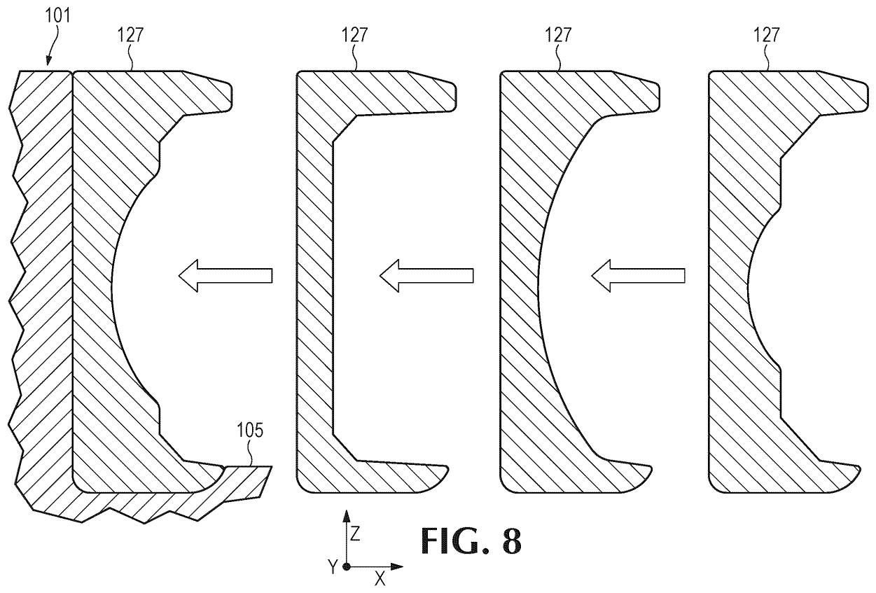

Accordingly, the contact zone 107 is made up of multiple zones, including an arcuate section 108 and a chamfered section 109. Although FIGS. 6 and 7 show an arcuate section 108 between two chamfered sections 109, other configurations are also contemplated. (For example, the examples described below for FIG. 8 are also contemplated for the configuration of FIGS. 6 and 7.) Even so, having an arcuate section 108 between two chamfered sections 109 is especially beneficial for accommodating mobile devices of different sizes as illustrated in FIGS. 6 and 7.

In configurations, the contact zone 107 is formed from a high-friction, compliant material. For example, the contact zone 107 may be formed from rubber or another elastomeric material to provide resilience and resistance to sliding or pivoting movement of the mobile device against the contact zone 107. In other configurations, the contact zone 107 is formed from or is coated by a relatively low-friction material.

In configurations, the contact zone 107 is on just one of the handles. In such configurations, the contact zone 107 may be on either one of the first handle 101 or the second handle 102. In configurations where the contact zone 107 is on just one of the handles, the other handle may be “plain.” The plain handle would not have both an arcuate section and a chamfered section. For example, at the location where the contact zone 107 would be, the plain handle may have as examples a flat wall, or a curved wall, or an arcuate section without a chamfered section, or a chamfered section without an arcuate section. Hence, the plain side would leave the mobile device 199 relatively less constrained than the side having the contact zone 107. In other configurations, the contact zone 107 may be on both the first handle 101 and the second handle 102, constraining the mobile device 199 at both handles.

FIG. 8 illustrates four examples of interchangeable, removable adapters, according to example configurations. As shown in FIG. 8, one or both of the first handle 101 and the second handle 102 includes a removable adapter 127. The removable adapter 127 includes the contact zone 107 as described above for FIGS. 6 and 7. As indicated in FIG. 8, any one of the removable adapters 127 could be installed into the handle at the same location as described above for FIGS. 5-7. As illustrated in FIG. 8, the removable adapters 127 may include, for example, an arcuate section 108 without a chamfered section 109, a chamfered section 109 without an arcuate section 108, an arcuate section 108 with two chamfered sections 109 having the proportions illustrated in FIGS. 5 and 6, and an arcuate section 108 with two chamfered sections 109 but having proportions that are different from what is illustrated in FIGS. 5 and 6. Otherwise, the configuration of FIG. 8 is as described above for FIGS. 6 and 7. The adapter 127 is removable in that the adapter 127 can be separated and moved away from the handle (the first handle 101 or the second handle 102) without causing permanent damage to either component. The removable adapter 127 is interchangeable in that another removable adapter 127 could be used in its place. Accordingly, if a first removable adapter 127 is not sufficient to align and constrain the mobile device 199 into the desired gameplay position, then the first removable adapter 127 could be removed from the handle and replaced by another removable adapter 127.

In configurations, one or both of the first handle 101 and the second handle 102 includes a contact zone 107 (as shown in FIGS. 6 and 7) and a removable adapter 127 may be installed over the contact zone 107 of the first handle 101 or the second handle 102. In such configurations, then, if the user's mobile device is securely restrained by the contact zone 107 of the first handle 101 or the second handle 102, then there is no need for the user to use one of the removable adapters 127. If, however, the user's mobile device is too large or too small to be securely restrained by the contact zone 107 of the first handle 101 or the second handle 102, then the user may install one or more removable adapters 127 on the first handle 101 or the second handle 102, or both.

In configurations, the game controller 100 might be part of a kit that includes more than one removable adapter 127, allowing the user to select an appropriate adapter 127 to install onto the handle (whether it be the first handle 101 or the second handle 102, or both handles). To accommodate various mobile devices, then, at least one of the removable adapters 127 has a cross-sectional profile that is not identical to the cross-sectional profile of another of the removable adapters 127.

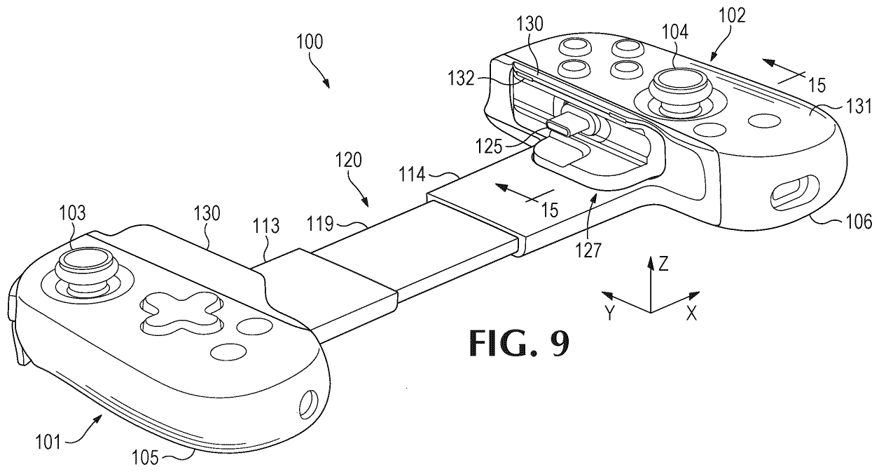

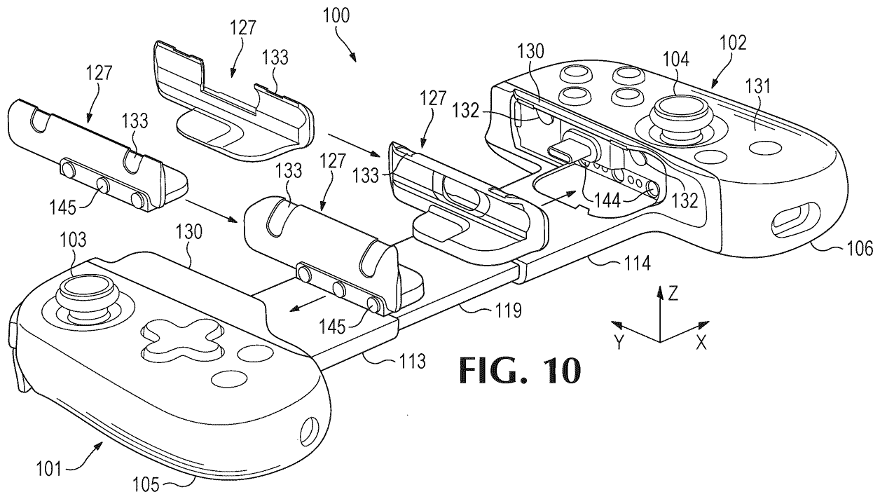

FIG. 9 illustrates another example of a game controller 100 that includes removable adapters 127. FIG. 10 is a partially exploded view of the game controller of FIG. 9, also showing examples of interchangeable, removable adapters 127, according to an example kit that includes more than one removable adapter 127. As illustrated in FIGS. 9-10, the kit may include a relatively small adapter and a relatively large adapter, where the relatively small adapter has a cross-sectional profile that is suitable for relatively small mobile devices 199 and the relatively large adapter has a cross-sectional profile that is suitable for relatively large mobile devices 199 or mobile devices 199 that are installed in a case. Accordingly, the user may select an appropriate adapter 127 to install onto the handle (whether it be the first handle 101 or the second handle 102, or both handles).

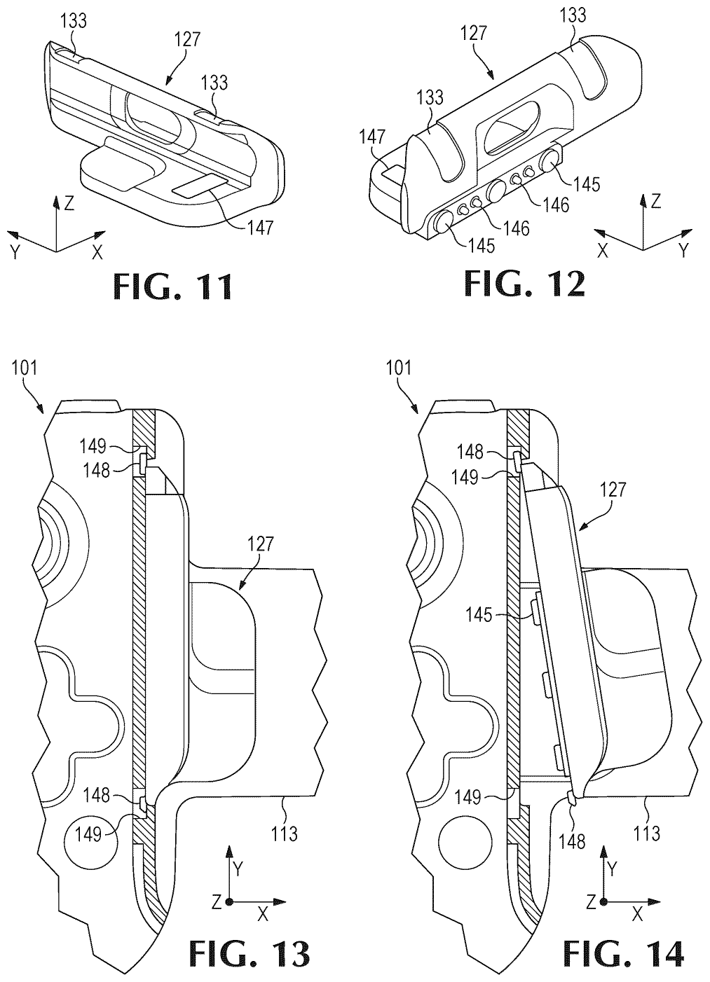

FIG. 11 illustrates a front, perspective view of an example adapter 127, and FIG. 12 illustrates a rear, perspective view of the example adapter 127 of FIG. 11. The removable adapter 127 illustrated in FIGS. 9-12 is as described for the removable adapters 127 illustrated in FIG. 8. In addition, as illustrated in FIGS. 11 and 12, the removable adapter 127, may include radio frequency (RF) technology, such as near-field communication (NFC) technology 147, to allow the removable adapter 127 to communicate with the game controller 100, with the mobile device 199, or with both. As used in this context, the term “NFC technology” means that the adapter 127 includes an NFC initiator or an NFC target. The NFC initiator generates a radio frequency (RF) field, while the NFC target, or tag, contains data that can be accessed by the NFC initiator through methods known in the art of near-field communications. Typically, the NFC target is in the adapter 127, while the NFC initiator is in another component, although those locations could be reversed in configurations. The corresponding NFC initiator or NFC target (i.e. the mate to the NFC initiator or the NFC target, as the case may be, of the removable adapter 127) is preferably located in the handle (whether it be the first handle 101 or the second handle 102), including in the guide portion 113, 114 of the handle, or in the bridge 119.

In configurations, the data on the NFC target could unlock user experiences for game play through the game controller 100 by changing an attribute of the game controller 100 or of a game being played through the game controller 100 by the user. For example, data on the NFC target could unlock extra game time; cause a game or other application to load to the mobile device 199; change colors, such as the button colors, or glyphs on the game controller 100, the mobile application, or the game being played through the game controller 100; send a signal to a mobile application running on the mobile device 199 to cause a change of operation of the game controller 100 or the mobile application; identify the user and cause a change of operation of the game controller 100, including for example a change colors or glyphs on the game controller 100, based on the particular user identified or on predetermined preferences for the particular user identified; allow the user to access digital goods through the mobile application; or provide instructions to the user through the mobile application, including, for example, how to properly install the adapter 127. The change of operation noted in the previous sentence may be, for example, customizing button mappings or other settings for buttons such as specific calibrations or otherwise allowing the user to modify game controller settings or modify mobile app settings. In other configurations, instead of data on the NFC target initiating the above features, those features could be enabled and initiated by other elements instead. For example, a button or other input element might cause those changes.

As best illustrated in FIGS. 10 and 12, the removable adapter 127, may be coupled to the handle (whether it be the first handle 101 or the second handle 102) by a magnetic connection. As illustrated, the handle may include a magnet 144, and the removable adapter 127 may include metal pins 145 or plates that are attracted to magnets. In other configurations, the magnet 144 may be on the adapter 127 and the metal pin 145 or plate may be on the handle. In still other configurations, connections other than or in addition to magnets may be used to couple the removable adapter 127 to the handle, including, as examples, a snap, a hook, hook-and-loop fastener, a mechanical latch with mating components, or an adhesive strip.

FIG. 13 illustrates an example of a mechanical latch with mating components to couple the removable adapter 127 to the handle. FIG. 14 illustrates the mechanical latch of FIG. 13 in an open, or unlatched, condition, showing how resilient tabs 148 on the removable adapter 127 may be inserted into slots 149 on the handle to couple the removable adapter 127 to the handle.

Returning to FIGS. 10 and 12, in configurations there is an electrical connection between the removable adapter 127 and the handle. For example, in configurations the removable adapter 127 and the handle include electrical connectors 146, such as pins or pogo pins, that provide electrical contact for the transfer of data or power, or both, between the removable adapter 127 and the handle. In configurations having a powered connection, the NFC technology residing on the removable adapter 127 may be powered in some configurations.

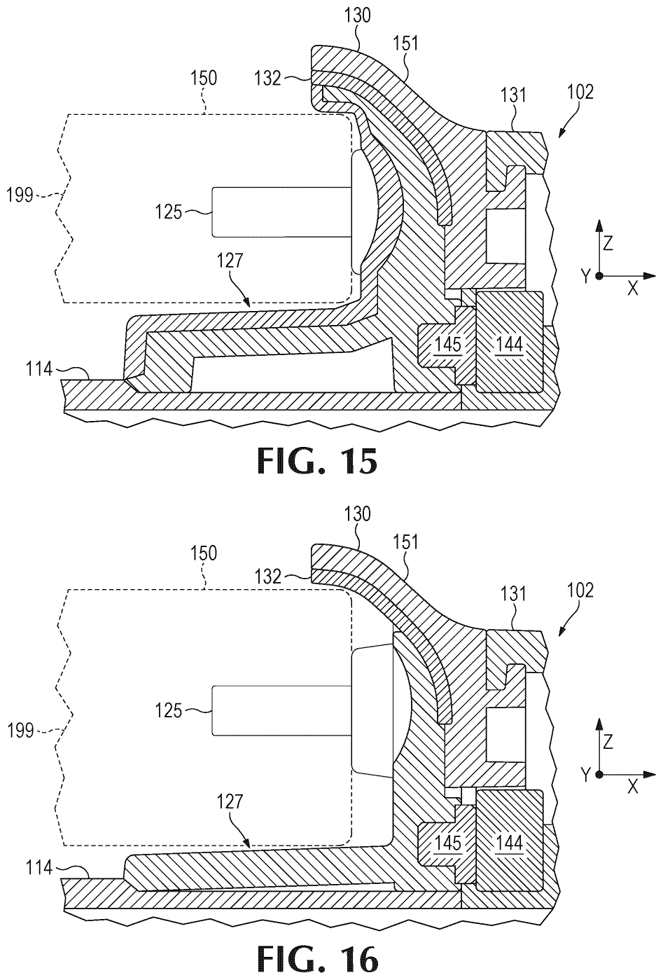

As best illustrated in FIGS. 10, 15, and 16, in configurations the main body portion of the handle (being the main body portion 105 of the first handle 101, the main body portion 106 of the second handle 102, or both) includes an overhang 130 to visually and mechanically guide the user when inserting the mobile device 199 or the removable adapter 127 into the game controller 100. In addition, the overhang 130 helps provide a more secure fit once the mobile device 199 is installed in the game controller 100 by securing either the mobile device 199 directly (an example of which is illustrated in FIG. 16) or by securing the removable adapter 127, which in turn secures the mobile device 199 (an example of which is illustrated in FIG. 15). As illustrated, the overhang 130 extends partially over an upper surface 150 of the mobile device 199. As illustrated, the overhang 130 constrains the mobile device 199 in the z-direction, providing a restoring force against twists in the x- and y-axes and resulting in a high-quality, secure feel for the user.

As illustrated in FIGS. 15 and 16, the overhang 130 rises in the z-direction over an upper surface 131 of the second handle 102. This creates a larger gap in the z-axis than would a lip that extends from the upper surface 131 of the handle but does not rise in the z-axis over the upper surface 131 of the second handle 102. In addition, the overhang 130 allows the game controller 100 to accommodate a mobile device 199 whose upper surface 150 is above the upper surface 131 of the handle in the z-axis. In other words, the overhang 130 allows the game controller 100 to accommodate a mobile device 199 that is thicker in the z-axis than could otherwise be accommodated. While illustrated in FIGS. 15 and 16 with respect to second handle 102, as shown in FIGS. 9 and 10 the overhang 130 could be on the first handle 101 or the second handle 102, or both.

As illustrated in FIGS. 15 and 16, the overhang 130 may include regions or strips of relatively higher friction, which are here referred to as “friction fangs” 132. For example, while the overhang 130 may be made from plastic or metal, as examples, the friction fangs 132 may be made from an elastomeric material. As a result, when compared to the remainder of the overhang 130, the friction fangs 132 provide more resistance to movement of the mobile device 199 because the friction fangs 132 have a higher static coefficient of friction and a higher kinetic coefficient of friction. In configurations, the friction fangs 132 align with and contact slots 133 in the removable adapter 127.

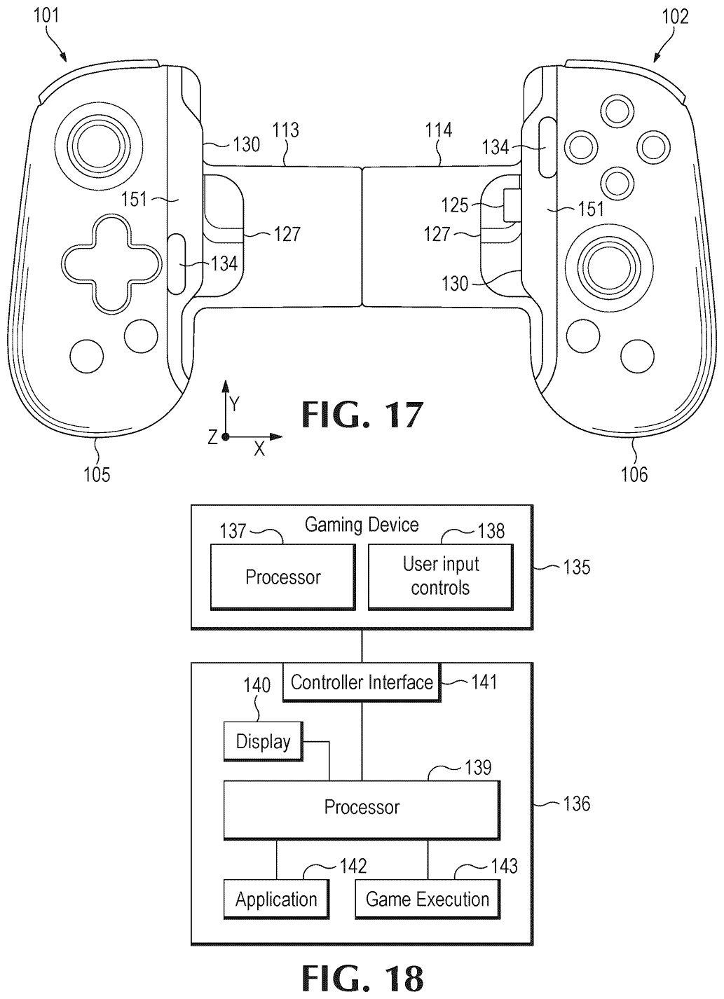

As illustrated in FIG. 17, in configurations the overhang 130 includes a thumb rest 134. In such configurations, the thumb rest 134 provides a tactile guide to the user as to the location of the hardware interface (for example, a button or directional pad). This allows the user quicker access to the hardware interface associated with the particular thumb rest 134 since the user would not be required to look at the game controller 100 to determine the location of the particular hardware interface. As illustrated in FIG. 17, the thumb rest 134 may be a divot or other tactile indentation in a portion of an upper surface 151 of the overhang 130 that is nearest to the particular hardware interface.

FIG. 18 is a functional block diagram of an example system for implementing the near-field technology discussed above. The system includes a gaming input device 135, which could be the game controller 100 discussed elsewhere in this document, and a computing device 136, which could be the mobile device 199 discussed elsewhere in this document. The gaming input device 135 may further include a processor 137 and user input controls 138. The gaming input device 135 may be, for example, the game controller for a mobile device as disclosed in U.S. Pat. No. 11,389,721.

As illustrated in FIG. 1, the computing device 136 may include a processor 139 and a display 140. The processor 139 executes an operating system of the computing device 136. The gaming input device 135 may be connected to the computing device 136 through a controller interface 141. When interfacing with the computing device 136, the gaming input device 135 may utilize the processor 139, the operating system, and the display 140 of the computing device 136 and may have access to data that is available to the processor 139 of the computing device 136. Such configurations provide the advantage of allowing the gaming input device 135 to access and utilize data, functionality, and results of the computing device 136.

In the illustrated configuration, an application 142 associated with the gaming input device 135 may be downloaded to the computing device 136, enabling the user to run games via one of multiple game execution modes 143, such as cloud gaming or locally-run gaming.

Accordingly, configurations of the disclosed technology reduce or eliminate positional misalignment of the mobile device during insertion into the handheld game controller. As a result, the user is not required to precisely align the mobile device with the game controller during insertion. Since some of the disclosed configurations automatically align the mobile device without user intervention, this provides a significantly improved user experience and reduces the risk of damage due to misalignment. In addition, some configurations provide a rigid, secure fit for the mobile device into the game controller. This secure fit communicates a premium feel to the product. In addition, the rigid, secure fit enables haptics generated from the mobile device to properly pass through to the handles of the game controller to the user holding the game controller.

### EXAMPLES

Illustrative examples of the disclosed technologies are provided below. A particular configuration of the technologies may include one or more, and any combination of, the examples described below.

Example 1 includes a gaming system, comprising: a handheld controller with a first handle and a second handle; a bridge connecting the first handle and the second handle, the bridge defining an x-y plane; and a contact zone on at least one of the first handle and the second handle, the contact zone configured to align and constrain a mobile device in a desired gameplay position that is substantially parallel to the x-y plane and between the first handle and the second handle, the contact zone having a cross-sectional profile in an x-z plane, the x-z plane being perpendicular to the x-y plane, the cross-sectional profile of the contact zone comprising an arcuate section and a chamfered section, the arcuate section having a radius and a center of curvature that is between the first handle and the second handle, the chamfered section comprising two substantially flat segments meeting at an obtuse angle, at least one of the two substantially flat segments having a length that is not less than one-quarter of the radius of the arcuate section.

Example 2 includes the gaming system of Example 1, in which the chamfered section further comprises a third substantially flat segment that meets at least one of the two substantially flat segments at an obtuse angle.

Example 3 includes the gaming system of any of Examples 1-2, in which the contact zone on at least one of the first handle and the second handle is a first contact zone on the first handle and a second contact zone on the second handle.

Example 4 includes the gaming system of any of Examples 1-3, in which the chamfered section is a first chamfered section, and in which the cross-sectional profile of the contact zone further comprises a second chamfered section, the arcuate section being between the first chamfered section and the second chamfered section in the cross-sectional profile of the contact zone.

Example 5 includes the gaming system of any of Examples 1-4, in which the bridge is in sliding engagement with the first handle and the second handle, the bridge having a span extending away from the first handle, the span having a transverse midline, the midline of the bridge being between the first handle and the second handle, the bridge and the first handle being configured for the first handle to translate in a retraction direction toward the midline of the bridge and into a retracted configuration and also to translate in an extension direction away from the midline of the bridge into an extended configuration, the bridge and the second handle being configured for the second handle to translate along the bridge in the retraction direction toward the midline of the bridge and into the retracted configuration and also to translate in the extension direction away from the midline of the bridge and into the extended configuration.

Example 6 includes the gaming system of Example 5, in which the contact zone is configured to align and constrain the mobile device in the desired gameplay position in the retracted configuration.

Example 7 includes the gaming system of any of Examples 1-6, further comprising a mobile device constrained between the first handle and the second handle in the desired gameplay position, the mobile device contacting the contact zone and being constrained to the desired gameplay position by the contact zone.

Example 8 includes a gaming device, comprising: a handheld controller with a first handle and a second handle; a bridge connecting the first handle and the second handle, the bridge defining an x-y plane; and a removable adapter on at least one of the first handle and the second handle, the adapter comprising a contact zone, the contact zone configured to align and constrain a mobile device in a desired gameplay position that is substantially parallel to the x-y plane and between the first handle and the second handle, the contact zone having a cross-sectional profile in an x-z plane perpendicular to the x-y plane, the cross-sectional profile of the contact zone comprising an arcuate section and a chamfered section, the arcuate section having a radius and a center of curvature that is between the first handle and the second handle, the chamfered section comprising two substantially flat segments meeting at an obtuse angle, at least one of the two substantially flat segments having a length that is not less than one-quarter of the radius of the arcuate section.

Example 9 includes the gaming device of Example 8, in which the chamfered section further comprises a third substantially flat segment that meets at least one of the two substantially flat segments at an obtuse angle.

Example 10 includes the gaming device of any of Examples 8-9, in which the contact zone on the at least one of the first handle and the second handle is a first contact zone on the first handle and a second contact zone on the second handle.

Example 11 includes the gaming device of any of Examples 8-10, in which the chamfered section is a first chamfered section, and in which the cross-sectional profile of the contact zone further comprises a second chamfered section, the arcuate section being between the first chamfered section and the second chamfered section in the cross-sectional profile of the contact zone.

Example 12 includes the gaming device of any of Examples 8-11, in which the bridge is in sliding engagement with the first handle and the second handle, the bridge having a span extending away from the first handle, the span having a transverse midline, the midline of the bridge being between the first handle and the second handle, the bridge and the first handle being configured for the first handle to translate in a retraction direction toward the midline of the bridge and into a retracted configuration and also to translate in an extension direction away from the midline of the bridge into an extended configuration, the bridge and the second handle being configured for the second handle to translate along the bridge in the retraction direction toward the midline of the bridge and into the retracted configuration and also to translate in the extension direction away from the midline of the bridge and into the extended configuration.

Example 13 includes the gaming device of Example 12, in which the contact zone is configured to align and constrain the mobile device in the desired gameplay position in the retracted configuration.

Example 14 includes the gaming device of any of Examples 8-13, in which the removable adapter further comprises near-field communication (NFC) technology.

Example 15 includes the gaming device of any of Examples 8-14, in which the removable adapter is configured to removably couple to the at least one of the first handle and the second handle by a magnetic connection.

Example 16 includes the gaming device of any of Examples 8-15, in which the removable adapter is configured to removably couple to the at least one of the first handle and the second handle by a mechanical latch.

Example 17 includes the gaming device of any of Examples 8-16, in which the removable adapter is connected to the at least one of the first handle and the second handle through an electrical connection.

Example 18 includes the gaming device of any of Examples 8-17, in which the x-y plane comprises an x-direction that is perpendicular to a y-direction, in which the at least one of the first handle and the second handle includes an overhang that extends from a main body portion of the at least one of the first handle and the second handle in a z-direction that is perpendicular to the x-direction and to the y-direction, the overhang also extending from the main body portion in the x-direction, the overhang configured to partially extend in the x-direction over an upper surface of the mobile device in the desired gameplay position and to constraint movement of the mobile device in the z-direction.

Example 19 includes the gaming device of Example 18, in which the overhang includes a friction fang comprising an elastomeric material configured to contact the mobile device when the mobile device is in the desired gameplay position.

Example 20 includes the gaming device of any of Examples 18-19, in which the overhang includes a tactile indentation in a portion of an upper surface of the overhang.

Example 21 includes a gaming device kit, comprising: a handheld controller with a first handle and a second handle; a bridge connecting the first handle and the second handle, the bridge defining an x-y plane, at least one of the first handle and the second handle configured to interchangeably receive a first removable adapter and a second removable adapter; a first removable adapter comprising a first contact zone, the first contact zone configured to align and constrain a mobile device in a desired gameplay position that is substantially parallel to the x-y plane and between the first handle and the second handle, the first contact zone having a first cross-sectional profile in an x-z plane perpendicular to the x-y plane, the first cross-sectional profile of the first contact zone comprising an arcuate section and a chamfered section, the arcuate section of the first contact zone having a radius and a center of curvature that is between the first handle and the second handle, the chamfered section of the first contact zone comprising two substantially flat segments meeting at an obtuse angle, at least one of the two substantially flat segments of the first contact zone having a length that is not less than one-quarter of the radius of the arcuate section; and a second removable adapter comprising a second contact zone, the second contact zone configured to align and constrain the mobile device in the desired gameplay position substantially parallel to the x-y plane and between the first handle and the second handle, the second contact zone having a second cross-sectional profile in an x-z plane perpendicular to the x-y plane, the second cross-sectional profile not being identical to the first cross-sectional profile, the second cross-sectional profile of the first contact zone comprising an arcuate section and a chamfered section, the arcuate section of the second contact zone having a radius and a center of curvature that is between the first handle and the second handle, the chamfered section of the second contact zone comprising two substantially flat segments meeting at an obtuse angle, at least one of the two substantially flat segments of the second contact zone having a length that is not less than one-quarter of the radius of the arcuate section.

Example 22 includes the gaming device kit of Example 21, in which the bridge is in sliding engagement with the first handle and the second handle, the bridge having a span extending away from the first handle, the span having a transverse midline, the midline of the bridge being between the first handle and the second handle, the bridge and the first handle being configured for the first handle to translate in a retraction direction toward the midline of the bridge and into a retracted configuration and also to translate in an extension direction away from the midline of the bridge into an extended configuration, the bridge and the second handle being configured for the second handle to translate along the bridge in the retraction direction toward the midline of the bridge and into the retracted configuration and also to translate in the extension direction away from the midline of the bridge and into the extended configuration.

Example 23 includes the gaming device kit of Example 22, in which each of the first contact zone and the second contact zone is configured to align and constrain the mobile device in the desired gameplay position in the retracted configuration.

Example 24 includes the gaming device kit of any of Examples 21-23, in which at least one of the first removable adapter and the second removable adapter further comprises near-field communication (NEC) technology.

Example 25 includes the gaming device kit of any of Examples 21-24, in which at least one of the first removable adapter and the second removable adapter is configured to removably couple to the at least one of the first handle and the second handle by a magnetic connection.

Example 26 includes the gaming device kit of any of Examples 21-25, in which at least one of the first removable adapter and the second removable adapter is configured to removably couple to the at least one of the first handle and the second handle by a mechanical latch.

Example 27 includes the gaming device kit of any of Examples 21-26, in which at least one of the first removable adapter and the second removable adapter is connected to the at least one of the first handle and the second handle through an electrical connection.

Example 28 includes the gaming device kit of any of Examples 21-27, in which the x-y plane comprises an x-direction that is perpendicular to a y-direction, in which the at least one of the first handle and the second handle includes an overhang that extends from a main body portion of the at least one of the first handle and the second handle in a z-direction that is perpendicular to the x-direction and to the y-direction, the overhang also extending from the main body portion in the x-direction, the overhang configured to partially extend in the x-direction over an upper surface of the mobile device in the desired gameplay position and to constraint movement of the mobile device in the z-direction.

Example 29 includes the gaming device kit of Example 28, in which the overhang includes a friction fang comprising an elastomeric material configured to contact the mobile device when the mobile device is in the desired gameplay position.

Example 30 includes the gaming device kit of any of Examples 28-29, in which the overhang includes a tactile indentation in a portion of an upper surface of the overhang.

Aspects of the present disclosure are described in this document with reference to flowchart illustrations or block diagrams of methods, apparatuses (systems), and computer program products according to example configurations of the disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart or block diagram block or blocks.

The non-transitory computer-readable media includes all types of computer-readable media, including magnetic storage media, optical storage media, and solid-state storage media and specifically excludes signals. It should be understood that the software can be installed in and sold with the device. Alternatively, the software can be obtained and loaded into the device, including obtaining the software via a disc medium or from any manner of network or distribution system, including, for example, from a server owned by the software creator or from a server not owned but used by the software creator. The software can be stored on a server for distribution over the internet, for example.

Computer-readable storage media (medium) exclude (excludes) propagated signals per se, can be accessed by a computer or processor(s), and include volatile and non-volatile internal or external media that is removable or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

For purposes of this document, each process associated with the disclosed technology may be performed continuously and by one or more computing devices. Each step in a process may be performed by the same or different computing devices as those used in other steps, and each step need not necessarily be performed by a single computing device.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

We claim:

1. A gaming system, comprising:
a handheld controller with a first handle and a second handle;
a bridge connecting the first handle and the second handle, the bridge defining an x-y plane; and
a contact zone on at least one of the first handle and the second handle, the contact zone configured to align and constrain a mobile device in a desired gameplay position that is substantially parallel to the x-y plane and between the first handle and the second handle, the contact zone having a cross-sectional profile in an x-z plane, the x-z plane being perpendicular to the x-y plane, the cross-sectional profile of the contact zone comprising an arcuate section and a chamfered section, the arcuate section having a radius and a center of curvature that is between the first handle and the second handle, the chamfered section comprising two substantially flat segments meeting at an obtuse angle, at least one of the two substantially flat segments having a length that is not less than one-quarter of the radius of the arcuate section.

2. The gaming system of claim 1, in which the chamfered section further comprises a third substantially flat segment that meets at least one of the two substantially flat segments at an obtuse angle.

3. The gaming system of claim 1, in which the contact zone on at least one of the first handle and the second handle is a first contact zone on the first handle and a second contact zone on the second handle.

4. The gaming system of claim 1, in which the chamfered section is a first chamfered section, and in which the cross-sectional profile of the contact zone further comprises a second chamfered section, the arcuate section being between the first chamfered section and the second chamfered section in the cross-sectional profile of the contact zone.

5. The gaming system of claim 1, in which the bridge is in sliding engagement with the first handle and the second handle, the bridge having a span extending away from the first handle, the span having a transverse midline, the midline of the bridge being between the first handle and the second handle, the bridge and the first handle being configured for the first handle to translate in a retraction direction toward the midline of the bridge and into a retracted configuration and also to translate in an extension direction away from the midline of the bridge into an extended configuration, the bridge and the second handle being configured for the second handle to translate along the bridge in the retraction direction toward the midline of the bridge and into the retracted configuration and also to translate in the extension direction away from the midline of the bridge and into the extended configuration.

6. The gaming system of claim 5, in which the contact zone is configured to align and constrain the mobile device in the desired gameplay position in the retracted configuration.

7. The gaming system of claim 1, further comprising a mobile device constrained between the first handle and the second handle in the desired gameplay position, the mobile device contacting the contact zone and being constrained to the desired gameplay position by the contact zone.

8. A gaming device, comprising:
a handheld controller with a first handle and a second handle;
a bridge connecting the first handle and the second handle, the bridge defining an x-y plane; and
a removable adapter on at least one of the first handle and the second handle, the adapter comprising a contact zone, the contact zone configured to align and constrain a mobile device in a desired gameplay position that is substantially parallel to the x-y plane and between the first handle and the second handle, the contact zone having a cross-sectional profile in an x-z plane perpendicular to the x-y plane, the cross-sectional profile of the contact zone comprising an arcuate section and a chamfered section, the arcuate section having a radius and a center of curvature that is between the first handle and the second handle, the chamfered section comprising two substantially flat segments meeting at an obtuse angle, at least one of the two substantially flat segments having a length that is not less than one-quarter of the radius of the arcuate section.

9. The gaming device of claim 8, in which the chamfered section further comprises a third substantially flat segment that meets at least one of the two substantially flat segments at an obtuse angle.

10. The gaming device of claim 8, in which the contact zone on the at least one of the first handle and the second handle is a first contact zone on the first handle and a second contact zone on the second handle.

11. The gaming device of claim 8, in which the chamfered section is a first chamfered section, and in which the cross-sectional profile of the contact zone further comprises a second chamfered section, the arcuate section being between the first chamfered section and the second chamfered section in the cross-sectional profile of the contact zone.

12. The gaming device of claim 8, in which the bridge is in sliding engagement with the first handle and the second handle, the bridge having a span extending away from the first handle, the span having a transverse midline, the midline of the bridge being between the first handle and the second handle, the bridge and the first handle being configured for the first handle to translate in a retraction direction toward the midline of the bridge and into a retracted configuration and also to translate in an extension direction away from the midline of the bridge into an extended configuration, the bridge and the second handle being configured for the second handle to translate along the bridge in the retraction direction toward the midline of the bridge and into the retracted configuration and also to translate in the extension direction away from the midline of the bridge and into the extended configuration.

13. The gaming device of claim 12, in which the contact zone is configured to align and constrain the mobile device in the desired gameplay position in the retracted configuration.

14. The gaming device of claim 3, in which the removable adapter further comprises near-field communication (NFC) technology.

15. The gaming device of claim 8, in which the removable adapter is configured to removably couple to the at least one of the first handle and the second handle by a magnetic connection.

16. The gaming device of claim 8, in which the removable adapter is configured to removably couple to the at least one of the first handle and the second handle by a mechanical latch.

17. The gaming device of claim 8, in which the removable adapter is connected to the at least one of the first handle and the second handle through an electrical connection.

18. The gaming device of claim 8, in which the x-y plane comprises an x-direction that is perpendicular to a y-direction, in which the at least one of the first handle and the second handle includes an overhang that extends from a main body portion of the at least one of the first handle and the second handle in a z-direction that is perpendicular to the x-direction and to the y-direction, the overhang also extending from the main body portion in the x-direction, the overhang configured to partially extend in the x-direction over an upper surface of the mobile device in the desired gameplay position and to constraint movement of the mobile device in the z-direction.

19. The gaming device of claim 18, in which the overhang includes a friction fang comprising an elastomeric material configured to contact the mobile device when the mobile device is in the desired gameplay position.

20. The gaming device of claim 18, in which the overhang includes a tactile indentation in a portion of an upper surface of the overhang.

21. A gaming device kit, comprising:
a handheld controller with a first handle and a second handle;
a bridge connecting the first handle and the second handle, the bridge defining an x-y plane, at least one of the first handle and the second handle configured to interchangeably receive a first removable adapter and a second removable adapter;
a first removable adapter comprising a first contact zone, the first contact zone configured to align and constrain a mobile device in a desired gameplay position that is substantially parallel to the x-y plane and between the first handle and the second handle, the first contact zone having a first cross-sectional profile in an x-z plane perpendicular to the x-y plane, the first cross-sectional profile of the first contact zone comprising an arcuate section and a chamfered section, the arcuate section of the first contact zone having a radius and a center of curvature that is between the first handle and the second handle, the chamfered section of the first contact zone comprising two substantially flat segments meeting at an obtuse angle, at least one of the two substantially flat segments of the first contact zone having a length that is not less than one-quarter of the radius of the arcuate section; and
a second removable adapter comprising a second contact zone, the second contact zone configured to align and constrain the mobile device in the desired gameplay position substantially parallel to the x-y plane and between the first handle and the second handle, the second contact zone having a second cross-sectional profile in an x-z plane perpendicular to the x-y plane, the second cross-sectional profile not being identical to the first cross-sectional profile, the second cross-sectional profile of the first contact zone comprising an arcuate section and a chamfered section, the arcuate section of the second contact zone having a radius and a center of curvature that is between the first handle and the second handle, the chamfered section of the second contact zone comprising two substantially flat segments meeting at an obtuse angle, at least one of the two substantially flat segments of the second contact zone having a length that is not less than one-quarter of the radius of the arcuate section.

22. The gaming device kit of claim 21, in which the bridge is in sliding engagement with the first handle and the second handle, the bridge having a span extending away from the first handle, the span having a transverse midline, the midline of the bridge being between the first handle and the second handle, the bridge and the first handle being configured for the first handle to translate in a retraction direction toward the midline of the bridge and into a retracted configuration and also to translate in an extension direction away from the midline of the bridge into an extended configuration, the bridge and the second handle being configured for the second handle to translate along the bridge in the retraction direction toward the midline of the bridge and into the retracted configuration and also to translate in the extension direction away from the midline of the bridge and into the extended configuration.

23. The gaming device kit of claim 22, in which each of the first contact zone and the second contact zone is configured to align and constrain the mobile device in the desired gameplay position in the retracted configuration.

24. The gaming device kit of claim 21, in which at least one of the first removable adapter and the second removable adapter further comprises near-field communication (NFC) technology.

25. The gaming device kit of claim 21, in which at least one of the first removable adapter and the second removable adapter is configured to removably couple to the at least one of the first handle and the second handle by a magnetic connection.

26. The gaming device kit of claim 21, in which at least one of the first removable adapter and the second removable adapter is configured to removably couple to the at least one of the first handle and the second handle by a mechanical latch.

27. The gaming device kit of claim 21, in which at least one of the first removable adapter and the second removable adapter is connected to the at least one of the first handle and the second handle through an electrical connection.

28. The gaming device kit of claim 21, in which the x-y plane comprises an x-direction that is perpendicular to a y-direction, in which the at least one of the first handle and the second handle includes an overhang that extends from a main body portion of the at least one of the first handle and the second handle in a z-direction that is perpendicular to the x-direction and to the y-direction, the overhang also extending from the main body portion in the x-direction, the overhang configured to partially extend in the x-direction over an upper surface of the mobile device in the desired gameplay position and to constraint movement of the mobile device in the z-direction.

29. The gaming device kit of claim 28, in which the overhang includes a friction fang comprising an elastomeric material configured to contact the mobile device when the mobile device is in the desired gameplay position.

30. The gaming device kit of claim 28, in which the overhang includes a tactile indentation in a portion of an upper surface of the overhang.
